(19) United States
(12) Patent Application Publication
(10) Pub. No.: US 2009/0096620 A1
(43) Pub. Date: Apr. 16, 2009

(54) FIRE ALARMING DEVICE

(76) Inventor: Chung-Yi KUO, Hsinchuang City (TW)

Correspondence Address: LEONG C LEI, PMB # 1008, 1867 YGNACIO VALLEY ROAD, WALNUT CREEK, CA, 94598, US

(21) Appl. No.: 11/872,728

(22) Filed: Oct. 16, 2007

(51) Int. Cl. G08B 17/10

(52) U.S. Cl. 340/628; 379/90.01; 455/404.1

(57) ABSTRACT

The fire alarming device contains a base member and a transparent dome member. A control circuit is housed inside the base member, and at least an infrared camera is housed inside the dome member. The camera can be manually adjusted so that it aims at a specific spot. The camera, as well as at least a smoke detector, is electrically and signally connected to the control circuit in the base member. The control circuit mainly contains a microprocessor, a memory for storing a control program executed by the microprocessor and other relevant data, and a radio transmitter and receiver unit. The radio transmitter and receiver unit is capable of making and receiving phone calls and sending and receiving messages (such as SMS or MMS or email) via a mobile communication network such as one of those supporting GSM and other appropriate protocols such as GPRS.

### (a) TECHNICAL FIELD OF THE INVENTION

The present invention generally relates to remote fire detection and alarming, and more particularly to a fire alarming device capable of issuing alarm via mobile communication network.

### (b) DESCRIPTION OF THE PRIOR ART

Conventional fire alarming system mainly relies on smoke detectors to detect the occurrence of fire. To remotely report fire alarm, the conventional system usually uses wired connectivity such as telephone lines, leased data lines, etc.

The wired approach has a number of disadvantages. First, the lines may be damaged by the fire so that the remote alarm cannot be transmitted. Secondly, the installation of the lines is laborious and therefore the fire alarming system using wired approach is more costly. Thirdly, the lines could be easily targeted for sabotage. Additionally, even though the remote alarm is indeed sent out, the person or party being alerted cannot readily see what is really happening on site to determine the proper action.

### SUMMARY OF THE INVENTION

The primary object of the present invention is to provide a novel fire alarming device, which utilizes a mobile communication network as the alarm transmission media and an image capturing device to provide first-hand on-site image.

The fire alarming device contains a base member and a transparent dome member joined to a bottom side of the base member. A control circuit is housed inside the base member, and at least an infrared camera is housed inside the dome member. The camera can be manually adjusted so that it aims at a specific spot. The camera, as well as at least a smoke detector, is electrically and signally connected to the control circuit in the base member. The control circuit mainly contains a microprocessor, a memory for storing a control program executed by the microprocessor and other relevant data, and a radio transmitter and receiver unit. The radio transmitter and receiver unit is capable of making and receiving phone calls and sending and receiving messages (such as SMS or MMS or email) via mobile communication networks such as those supporting GSM and other appropriate protocols such as GPRS.

The foregoing objectives and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a fire alarming device according to an embodiment of the present invention.

FIG. 2 is a perspective exploded view showing the various components of the fire alarming device of FIG. 1.

FIG. 3 is a functional block diagram of the fire alarming device of FIG. 1.

FIG. 4 is a schematic view showing an application scenario of the fire alarming device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

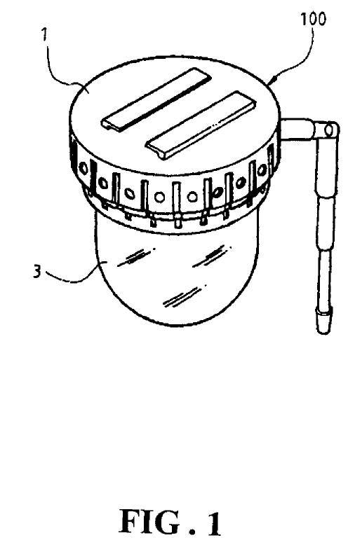

As shown in FIG. 1, a fire alarming device 100 according to an embodiment of the present invention contains a base member 1 and a transparent dome member 3 joined to a bottom side of the base member 1. The fire alarming device 100 is installed by attaching a top side of the base member 1 to the ceiling of the area to be monitored.

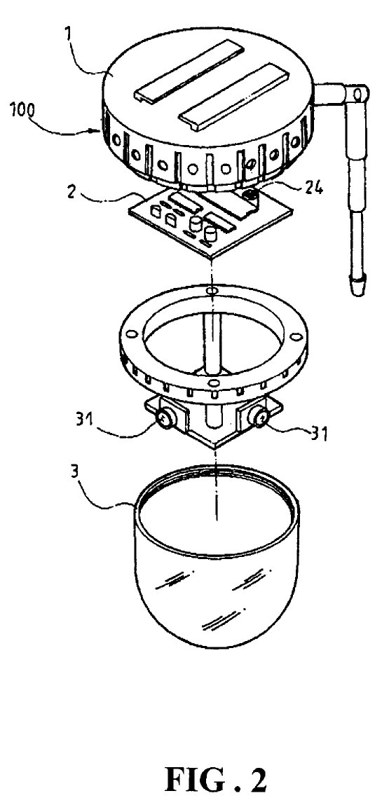

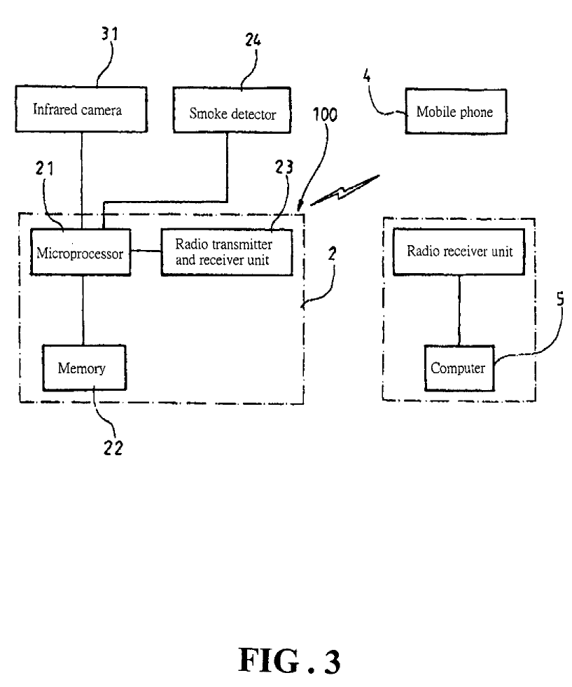

As shown in FIGS. 2 and 3, a control circuit 2 is housed inside the base member 1, and at least an infrared camera 31 is housed inside the dome member 3. The camera 31 can be manually adjusted so that it aims at a specific spot. The camera 31, as well as a smoke detector 24, is electrically and signally connected to the control circuit 2 in the base member 1. The control circuit 2 mainly contains a microprocessor 21, a memory 22 for storing a control program executed by the microprocessor 21 and other relevant data, and a radio transmitter and receiver unit 23. The radio transmitter and receiver unit 23 is capable of making and receiving phone calls and sending and receiving messages (such as SMS or MMS or email) via a mobile communication network such as one of those supporting GSM and other appropriate protocols such as GPRS. In other words, the radio transmitter and receiver unit 23 may contain a SIM card and has an assigned mobile phone number.

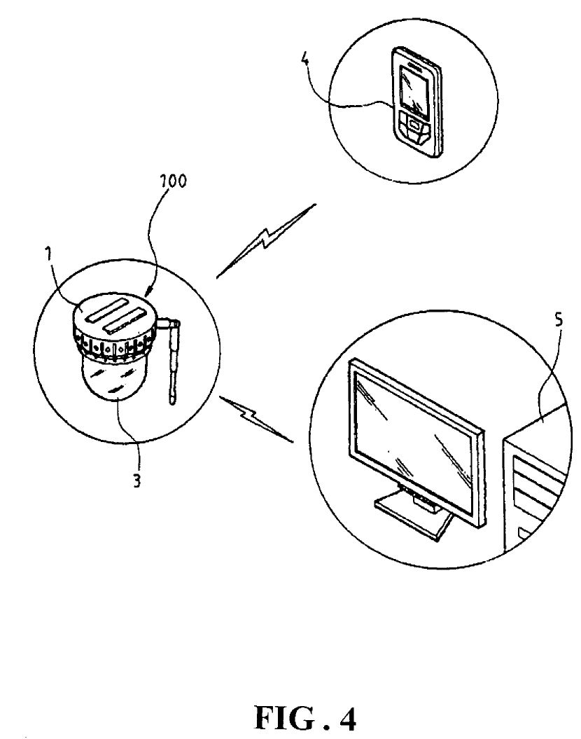

As illustrated in FIGS. 3 and 4, the operation scenario of the fire alarming device is as follows. If the smoke detector 24 has detected some excessive amount of smoke, the microprocessor 21 is triggered by the smoke detector 24 to perform a number of tasks. The microprocessor 21 may dial a pre-configured phone number (a part of the relevant data stored in the memory 22) through the radio transmitter and receiver unit 23. The number could be the number to the house owner's mobile phone 4 or the number to the local fire department. When the called party answers the call, the microprocessor 21 may play a pre-recorded message (another part of the relevant data stored in the memory 22). If the called party's line is busy or the call is not answered after a period of time, the microprocessor 21 may retry for a number of times at fixed intervals (again, all these parameters are parts of the relevant data stored in the memory 22).

Alternatively or additionally, the microprocessor 21 may capture an on-site image by the infrared camera 31, and send the image in a SMS or MMS message to the mobile phone 4 by the pre-configured number, or as an attachment to an email to a pre-configured email address (also a part of the relevant data stored in the memory 22) of a computer 5, both via the radio transmitter and receiver unit 23.

On the other hand, a user could also remotely trigger the microprocessor 21 in one of two ways so that the fire alarming device 100 could also function as a surveillance device. First, the user can call the radio transmitter and receiver unit 23's assigned mobile phone number. The microprocessor 21 therefore would be triggered by the radio transmitter and receiver unit 23. Then, through the received Caller ID, the microprocessor 21 could determine whether to respond to his call. If the Caller ID matches a pre-configured number (again, a part of the relevant data stored in the memory 22), the microprocessor 21 captures an on-site image by the infrared camera 31, and send the image in a SMS or MMS message to the mobile phone 4, or as an attachment to an email to the computer 5, both via the radio transmitter and receiver unit 23.

In the other way, the user can trigger the above described operation of the microprocessor 21 by sending a short message to the radio transmitter and receiver unit 23's assigned mobile phone number. In an alternative embodiment, the short message may contain instruction to the microprocessor 21 so that the image is sent to a separate mobile phone or another email address, instead of the default ones specified in the memory 22.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fire alarming device, comprising:
a base member having a top side attached to a ceiling and a control circuit housed inside, said control circuit having a microprocessor, a memory storing a control program executed by said microprocessor and relevant data, and a radio transmitter and receiver unit capable of making and receiving phone calls and sending and receiving messages via a mobile communication network;
a transparent dome member joined to a bottom side of said base member, said dome member having at least an infrared camera housed inside whose viewing direction is manually adjustable, said infrared camera electrically and signally connected to said control circuit; and
at least a smoke detector electrically and signally connected to said control circuit;
wherein, when said smoke detector has detected some excessive amount of smoke, said microprocessor is triggered to dial a pre-configured phone number through said radio transmitter and receiver unit to issue a voice alarm when a called party answers; and, when said smoke detector has detected some excessive amount of smoke, said microprocessor is triggered to capture an image by said infrared camera, and send said image in a message to one of a pre-configured mobile phone number and an email address.

2. The fire alarming device according to claim 1, wherein, when said radio transmitter and receiver unit receives one of a call and a message, said microprocessor is triggered to capture an image by said infrared camera, and send said image in a message to one of a mobile phone number and an email address.
